(19) United States
(12) Patent Application Publication
(10) Pub. No.: US 2026/0274139 A1
(43) Pub. Date: Sep. 17, 2026

(54) VEHICLE STORAGE DEVICE

(71) Applicants: NHK SPRING CO., LTD., Yokohama-shi (JP); SUBARU CORPORATION, Tokyo (JP)

(72) Inventors: Yuko TAKIMOTO, Yokohama-shi (JP); Hikaru SUGURO, Yokohama-shi (JP); Atsuhiro TOMINAGA, Tokyo (JP)

(21) Appl. No.: 19/565,745

(22) Filed: Mar. 13, 2026

(30) Foreign Application Priority Data
Mar. 14, 2025 (JP) 2025-041924

(51) Int. Cl. B60N 3/10; B60N 3/00

(52) U.S. Cl. CPC B60N 3/102; B60N 3/004; B60N 3/104

(57) ABSTRACT

A vehicle storage device includes a first floor coupling panel, a second floor coupling panel, and a third floor coupling panel that are respectively rotatably coupled to edge portions of an opening section of an underfloor storage chamber, and a first seat coupling panel, a second seat coupling panel, and a third seat coupling panel that are rotatably coupled to a back face of a seatback of the rear seat. In the storage device, the opening section of the underfloor storage chamber is configured to be openable/closeable by the first floor coupling panel and the second floor coupling panel. These coupling panels are able to form a storage box having an interior in communication with the inside of the underfloor storage chamber at a vehicle upper side of the underfloor storage chamber.

### CROSS-REFERENCE TO RELATED APPLICATION

This application is based on and claims priority under 35 USC 119 from Japanese Patent Application No. 2025-041924 filed on Mar. 14, 2025, the disclosure of which is incorporated by reference herein.

### BACKGROUND

### TECHNICAL FIELD

The present disclosure relates to a vehicle storage device.

### RELATED ART

A vehicle storage device disclosed in Japanese Patent Application Laid-Open (JP-A) No. 2006-150996 includes a recessed part formed on a member inside a vehicle cabin, such as a seatback, deck board, or the like, a storage box formation member deformable between a state coupled to the recessed part and stowed folded away inside the recessed part, and a state forming a storage box pulled out from the recessed part, and a lid body that opens/closes an opening section of the recessed part, such that the opening section of the storage box is opened or closed by the lid body.

### SUMMARY

In the related art described above, the storage box formation member is stowed inside the recessed part formed to the member inside the vehicle cabin, such as to the seatback, deck board, or the like, and so objects are not able to be stored in the recessed part in a stowed state of the storage box formation member. There is accordingly room for improvement from the perspective of improving convenience.

An object of the present disclosure is to obtain a vehicle storage device capable of improving convenience.

A vehicle storage device of a first aspect of the present disclosure includes an underfloor storage chamber that is formed under a floor of a luggage space at a vehicle rear side of a vehicle rear seat and that is open to a vehicle upper side, plural floor coupling panels rotatably coupled to edge portions of an opening section of the underfloor storage chamber, and plural seat coupling panels rotatably coupled to a back face of a seatback of the rear seat. In the vehicle storage device, the opening section of the underfloor storage chamber is configured to be openable/closeable by one or more of the floor coupling panels, and the plural floor coupling panels and the plural seat coupling panels are able to form a storage box having an interior in communication with an inside of the underfloor storage chamber at a vehicle upper side of the underfloor storage chamber.

In the vehicle storage device of the first aspect, the underfloor storage chamber formed under the floor of the luggage space at the vehicle rear side of the vehicle rear seat is open to the vehicle upper side. The plural floor coupling panels are rotatably coupled to the edge portion of the opening section of the underfloor storage chamber, and the plural seat coupling panels are rotatably coupled to the back face of the seatback of the rear seat. In this storage device, the opening section of the underfloor storage chamber is openable/closeable by the one or more floor coupling panels. Moreover, the plural floor coupling panels and the plural first seat coupling panel are able to form the storage box having an interior in communication with the inside of the underfloor storage chamber at the vehicle upper side of the underfloor storage chamber. Due to the storage device not being configured with the coupling panels stowed inside the underfloor storage chamber, objects can be stored inside the underfloor storage chamber even in a state in which the storage box is not formed. This thereby enables convenience to be improved.

A vehicle storage device of a second aspect is the first aspect, wherein one floor coupling panel forming a side wall of the storage box from among the plural floor coupling panels includes a frame configuring an outer edge portion of the one floor coupling panel, and a plate-shaped section that fits to an inside of the frame, and the frame and the plate-shaped section are each rotatably coupled to an edge portion of the opening section, and are each able to be stowed so as to be parallel to a floor surface of the luggage space.

In the vehicle storage device of the second aspect, an opening section can be formed in the side wall of the storage box by, from the one floor coupling panel forming the storage box side wall, stowing only the plate-shaped section so as to be parallel to the floor surface (for example, superimposed on the floor surface) of the luggage space. This thereby facilitates access to the inside of the storage box. Moreover, for example, the storage box can be used as a table by a vehicle passenger sitting on the plate-shaped section with feet entered inside the storage box and the underfloor storage chamber through the opening section of this side wall.

A vehicle storage device of the third aspect is the second aspect, wherein the plate-shaped section is a plate-shaped cushion.

In the vehicle storage device of the third aspect, good passenger seating comfort can be achieved due to plate-shaped section that the vehicle passenger is sitting on being the plate-shaped cushion as described above.

A vehicle storage device of a fourth aspect is the vehicle storage device of any one aspect of the first aspect to the third aspect, further including plural heaters that are able to respectively heat a floor surface of the luggage space, the inside of the underfloor storage chamber, and an inside of the storage box.

In the vehicle storage device of the fourth aspect, for example, the comfort of a pet, such as a dog, lying in the luggage space can be improved by heating the floor surface of the luggage space with the heaters. Moreover, the heaters inside the underfloor storage chamber can heat in a state in which the storage box is not formed, and the respective heaters inside the underfloor storage chamber and the storage box can heat in a state in which the storage box has been formed.

As described above, the vehicle storage device according to the present disclosure is able to improved convenience.

### BRIEF DESCRIPTION OF THE DRAWINGS

Exemplary embodiments of the present invention will be described in detail based on the following figures, wherein:

FIG. 1 is a partial cross-section illustrating a stowed state of a storage box in a vehicle storage device according to an exemplary embodiment;

FIG. 2 is a partial cross-section illustrating a deployed state of the storage box in the same storage device;

FIG. 3 is a perspective view illustrating the stowed state of the storage box in the same storage device;

FIG. 4 is a perspective view illustrating the deployed state of the storage box in the same storage device;

FIG. 5 is a plan view illustrating the stowed state of the storage box in the same storage device;

FIG. 6 is a cross-section illustrating the deployed state of the storage box in the same storage device;

FIG. 7 is a cross-section illustrating an enlargement of part of the configuration illustrated in FIG. 2;

FIG. 8A is a perspective view to explain heating of a floor surface of a luggage space;

FIG. 8B is a cross-section to explain heating of the floor surface of the luggage space;

FIG. 9A is a perspective view to explain heating of an underfloor storage chamber;

FIG. 9B is a cross-section to explain heating of the underfloor storage chamber;

FIG. 10A is a perspective view to explain heating of a floor surface of a luggage space and an underfloor storage chamber;

FIG. 10B is a cross-section to explain heating of the floor surface of the luggage space and an underfloor storage chamber;

FIG. 11A is a perspective view to explain heating of an underfloor storage chamber and a storage box;

FIG. 11B is a cross-section to explain heating of the underfloor storage chamber and the storage box;

FIG. 12A is a perspective view to explain an underfloor storage chamber and a storage box when used as a kotatsu; and

FIG. 12B is a cross-section to explain the underfloor storage chamber and the storage box when used as a kotatsu.

### DETAILED DESCRIPTION

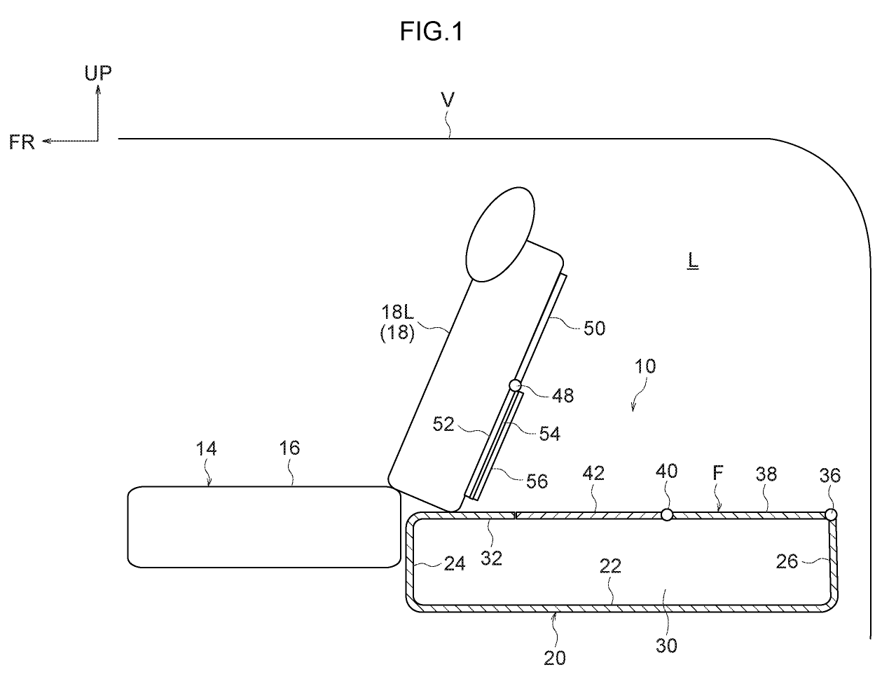

Description follows regarding a vehicle storage device 10 according to an exemplary embodiment of the present disclosure (hereinafter simply referred to as “storage device 10”), with reference to FIG. 1 to FIG. 12B. Note that some of the reference numerals are omitted in the drawings in order to improve clarity of the drawings. Moreover, as appropriate in the drawings, arrows FR, LH, RH, and UP respectively indicate forward, leftward, rightward, and upward directions of a vehicle V provided with the vehicle storage device 10. Hereinafter, when reference is simply given to front and rear, left and right, up and down in the following description then this indicates directions with respect to the vehicle V.

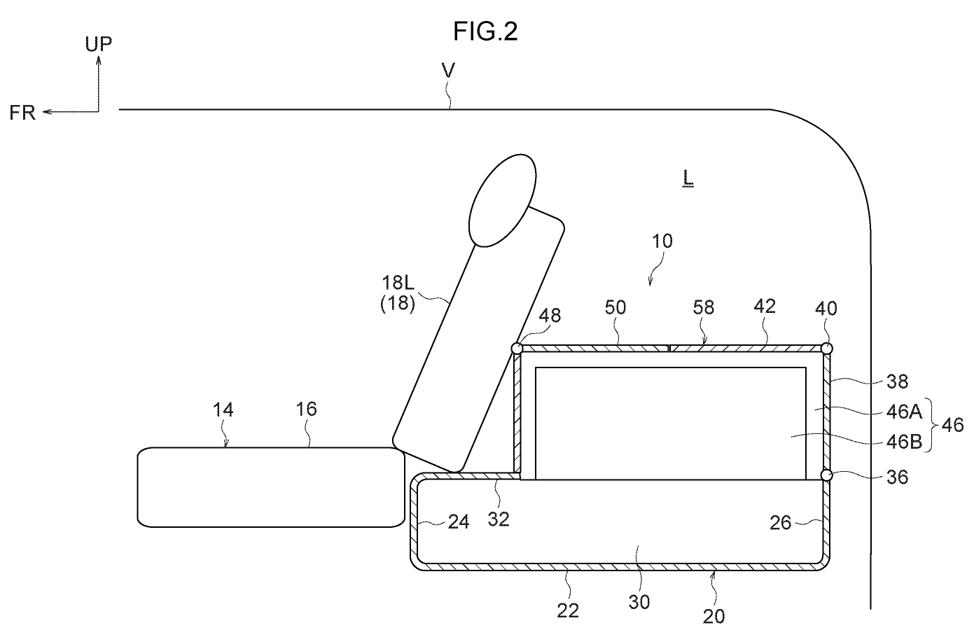

As illustrated in FIG. 1 and FIG. 2, the vehicle V provided with the vehicle storage device 10 according to the present exemplary embodiment is, for example, a station wagon or minivan type of vehicle, and includes a luggage space L at a rear of a three-person rear seat 14. A seatback 18 of the rear seat 14 is, as an example, a 6:4 ratio dividing type of seat, divided into a two-person left seatback 18L, and a one-person right seatback 18R.

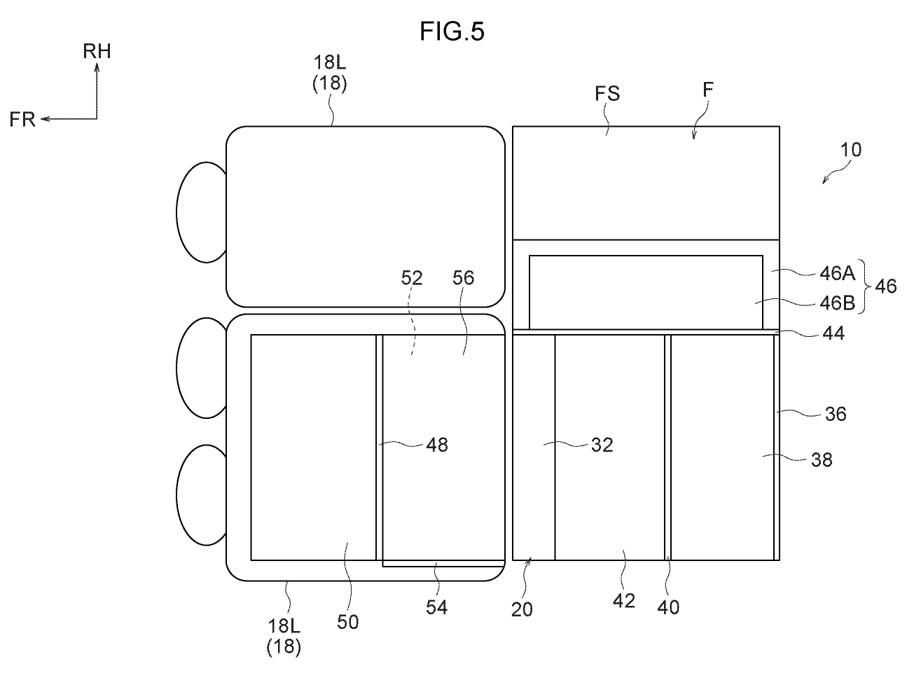

As illustrated in FIGS. 1 - 5,an underfloor storage chamber (underfloor storage unit) 20 is formed under the floor of the luggage space L at the rear of the left seatback 18L. Note that a state illustrated in FIG. 5 is a state in which the left seatback 18L and the right seatback 18R have been tilted forward onto a seat cushion 16 (see FIGS. 1 - 4 of the rear seat 14.

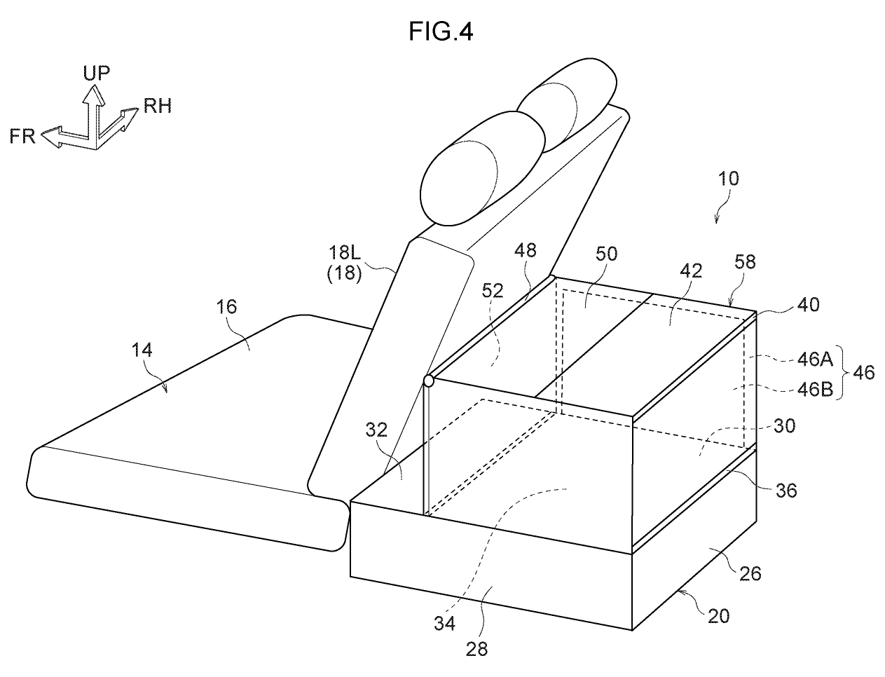

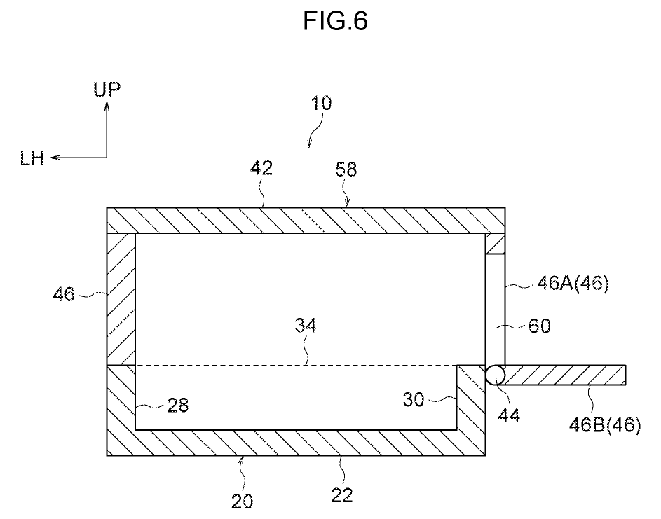

The underfloor storage chamber 20 includes a lower wall 22, a front wall 24, a rear wall 26, a left wall 28, a right wall 30, and an upper wall 32. The upper wall 32 is provided only to a front portion of the underfloor storage chamber 20, and an opening section 34 (see FIGS. 4 and 6) is formed between a rear end portion of the upper wall 32 and an upper end portion of the rear wall 26. The underfloor storage chamber 20 is open upward at the opening section 34.

A plate-shaped first floor coupling panel 38 is rotatably coupled to the upper end portion of the rear wall 26, namely to a rear edge portion of the opening section 34, through a first hinge section 36 having an axial-line direction along the left-right direction. At an end portion of the first floor coupling panel 38 on the opposite side to the first hinge section 36, a plate-shaped second floor coupling panel 42 is rotatably coupled through a second hinge section 40 having an axial-line direction along the left-right direction. The first floor coupling panel 38 and the second floor coupling panel 42 are, for example, configured from a resin or a metal.

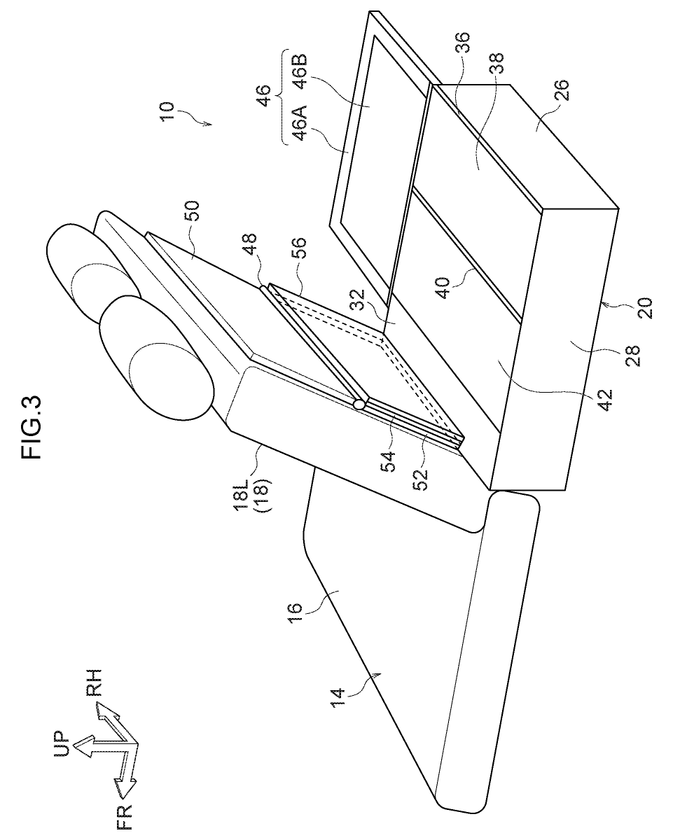

The second floor coupling panel 42 is coupled to a rear edge portion of the opening section 34 through the second hinge section 40, the first floor coupling panel 38, and the first hinge section 36. As illustrated in FIGS. 1 and 3, the opening section 34 of the underfloor storage chamber 20 is configured to be openable/closeable by the first floor coupling panel 38 and the second floor coupling panel 42. In a state in which the opening section 34 has been closed off by the first floor coupling panel 38 and the second floor coupling panel 42 in this manner, the first floor coupling panel 38 and the second floor coupling panel 42 configure a floor F of the luggage space L.

A plate-shaped third floor coupling panel 46 is rotatably coupled to an upper end portion of the right wall 30, namely to a right edge portion of the opening section 34, through a third hinge section 44 having an axial-line direction along the front-rear direction. The first floor coupling panel 38, the second floor coupling panel 42, and the third floor coupling panel 46 correspond to “floor coupling panels” of the present disclosure.

The third floor coupling panel 46 is configured from a frame 46A configuring an outer edge portion of the third floor coupling panel 46, and a plate-shaped section 46B fitted to the inside of the frame 46A. The frame 46A is, for example, configured from a resin or metal formed into a channel shape (substantially, U-shape). The frame 46A is, for example, covered by a cover formed from a cloth material or the like. The plate-shaped section 46B is a plate-shaped cushion, configured from a foam body of urethane foam or the like, covered by a cover formed from a cloth material or the like. The frame 46A and the plate-shaped section 46B are each coupled to the right edge portion of the opening section 34 through the third hinge section 44.

A plate-shaped first seat coupling panel 50 is rotatably coupled to a height direction intermediate portion of a back face of the left seatback 18L through a fourth hinge section 48 having an axial-line direction along the left-right direction. The first seat coupling panel 50 is, for example, configured from a resin. As illustrated in FIG. 1 and FIG. 3, the first seat coupling panel 50 is configured so as to be rotatable toward a stowed position superimposed on an upper section of the back face of the left seatback 18L, and is restrained by a non-illustrated lock mechanism at this stowed position.

Moreover, a plate-shaped second seat coupling panel 52 is rotatably coupled to a height direction intermediate portion of the back face of the left seatback 18L through the fourth hinge section 48. A plate-shaped third seat coupling panel 56 is rotatably coupled to a left end portion of the second seat coupling panel 52 through a fifth hinge section 54 having an axial-line direction in a direction along the left end portion of the second seat coupling panel 52. The second seat coupling panel 52 and the third seat coupling panel 56 are, for example, configured from a resin. The first seat coupling panel 50, the second seat coupling panel 52, and the third seat coupling panel 56 correspond “seat coupling panels” of the present disclosure.

The third seat coupling panel 56 is coupled to the back face of the left seatback 18L through the fifth hinge section 54, the second seat coupling panel 52, and the fourth hinge section 48. As illustrated in FIG. 1 and FIG. 3, the second seat coupling panel 52 is rotatable to a stowed position superimposed on a lower section of the back face of the left seatback 18L, and the third seat coupling panel 56 is rotatable to a stowed position superimposed on the back face of the second seat coupling panel 52 positioned in the stowed position. The second seat coupling panel 52 and the third seat coupling panel 56 are configured so as to be restrained by non-illustrated lock mechanism(s) at these stowed positions.

In the vehicle storage device 10 configured as described above, as illustrated in FIG. 2 and FIG. 4, the first floor coupling panel 38, the second floor coupling panel 42, the third floor coupling panel 46, the first seat coupling panel 50, the second seat coupling panel 52, and the third seat coupling panel 56 are able to form a storage box 58 having an interior in communication with the inside of the underfloor storage chamber 20 above the underfloor storage chamber 20.

When forming the storage box 58, firstly the first floor coupling panel 38 and the second floor coupling panel 42 are lifted up, opening the opening section 34 of the underfloor storage chamber 20. Then after that, the restraint of the second seat coupling panel 52 and the third seat coupling panel 56 is released and, as illustrated in FIG. 2 and FIG. 4, the second seat coupling panel 52 is stood upright above a rear end portion of the upper wall 32, the third seat coupling panel 56 is stood upright above the left wall 28, and also the third floor coupling panel 46 is stood upright above the right wall 30.

The second floor coupling panel 42 is installed to the respective upper end portions of the third floor coupling panel 46 and the third seat coupling panel 56, and the first floor coupling panel 38 is stood upright above the rear wall 26. Furthermore, the restraint of the first seat coupling panel 50 is released, and the first seat coupling panel 50 is mounted to respective upper end portions of the third floor coupling panel 46 and the third seat coupling panel 56. The storage box 58 is formed thereby.

In the storage box 58, the side walls are configured by the first floor coupling panel 38, the third floor coupling panel 46, the second seat coupling panel 52, and the third seat coupling panel 56, and a top wall is configured by the second floor coupling panel 42 and the first seat coupling panel 50.

Note that the first floor coupling panel 38, the third floor coupling panel 46, the second seat coupling panel 52, and the third seat coupling panel 56 are, for example, restrained in an upright state by non-illustrated lock mechanisms provided to the first hinge section 36, the third hinge section 44, the fourth hinge section 48, and the fifth hinge section 54. These lock mechanisms are, for example, configured to restrict rotatable angles of each of the hinge sections 36, 44, 48, 54 to specific ranges.

In the third floor coupling panel 46, the frame 46A and the plate-shaped section 46B are respectively rotatably coupled to the right edge portion of the opening section 34, with the frame 46A and the plate-shaped section 46B respectively configured so as to be stowable superimposed on a floor surface FS of the luggage space L (see FIG. 5). As illustrated in FIG. 6, a configuration is adopted such that when the frame 46A of the third floor coupling panel 46 is placed upright, only the plate-shaped section 46B is stowed so as to be parallel to the floor surface FS (in this case superimposed on the floor surface FS), and an opening section 60 is formed in the right side wall of the storage box 58.

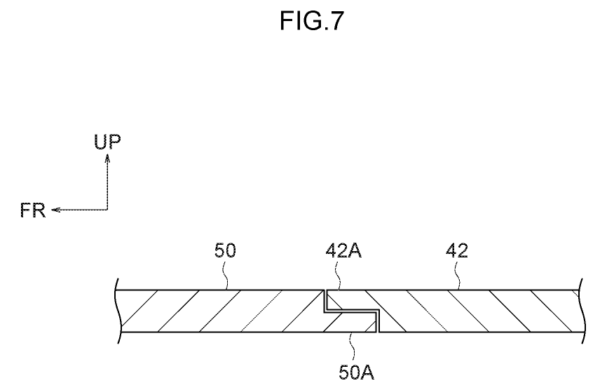

Moreover, in the state in which the storage box 58 has been formed, as illustrated in FIG. 7, a step portion 42A formed to a front end portion of the second floor coupling panel 42, and a step portion 50A formed to a rear end portion of the first seat coupling panel 50, are configured so as to be superimposed above and below each other. A configuration is accordingly achieved so as to increase the strength when objects are placed on the first seat coupling panel 50 and the second floor coupling panel 42. Note that FIG. 2 illustrates a schematic diagram of a front end portion of the second floor coupling panel 42 and a rear end portion of the first seat coupling panel 50.

In the vehicle storage device 10 configured as described above, the floor surface FS of the luggage space L includes plural heaters (omitted in the drawings) capable of respectively heating the inside of the underfloor storage chamber 20 and the inside of the storage box 58. Specifically, the floor F of the luggage space L is able to be heated by planar heaters attached to the first floor coupling panel 38, the second floor coupling panel 42, and the plate-shaped section 46B of the third floor coupling panel 46.

Moreover, the inside of the underfloor storage chamber 20 is able to be heated by planar heaters attached to the lower wall 22, the front wall 24, the rear wall 26, the left wall 28, and the right wall 30. Moreover, the inside of the storage box 58 is able to be heated by planar heaters attached to the first floor coupling panel 38, the second floor coupling panel 42, the plate-shaped section 46B of the third floor coupling panel 46, the first seat coupling panel 50, the second seat coupling panel 52, and the third seat coupling panel 56.

A temperature sensor is attached to the inside of the underfloor storage chamber 20 (in this case to the upper wall 32), in a configuration in which the temperature inside the underfloor storage chamber 20 and inside the storage box 58 can be controlled by a non-illustrated control device. Moreover, the control device is configured so as to operate the heaters inside the underfloor storage chamber 20 and inside the storage box 58 only when the underfloor storage chamber 20 and the storage box 58 are in a tightly sealed state, such that safety and energy efficiency are secured. The storage space within the underfloor storage chamber 20 can accommodate food such as pizza, cake, sushi, and other items, stored horizontally relative to the vehicle V. Furthermore, the above storage space can be expanded upward by forming the storage box 58.

The inside of the underfloor storage chamber 20 and the inside of the storage box 58 are able to be tightly sealed, thereby achieving a configuration in which smells of the food inside the underfloor storage chamber 20 and inside the storage box 58 are suppressed from leaking inside the vehicle cabin. Moreover, the inside of the underfloor storage chamber 20 and the inside of the storage box 58 have, for example, a thermal-insulation-material-attached waterproof sheet stuck thereto, thereby suppressing liquids from flowing out into the luggage space L, and making it easy to wipe up any soiling inside the underfloor storage chamber 20 and inside the storage box 58.

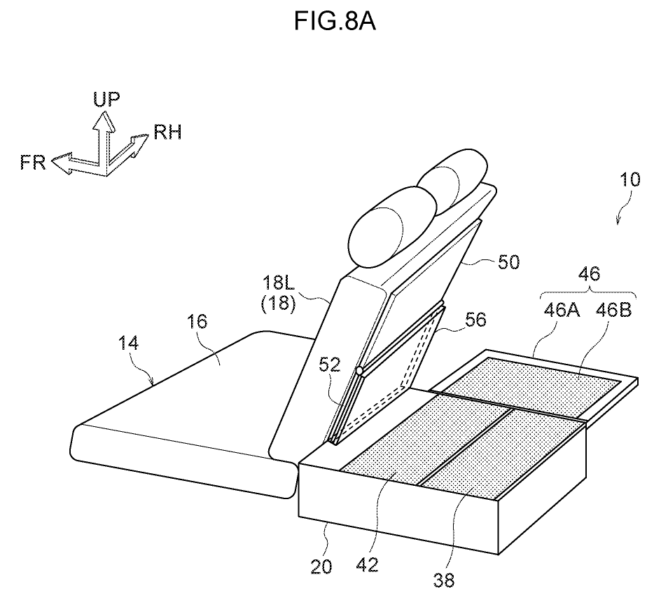

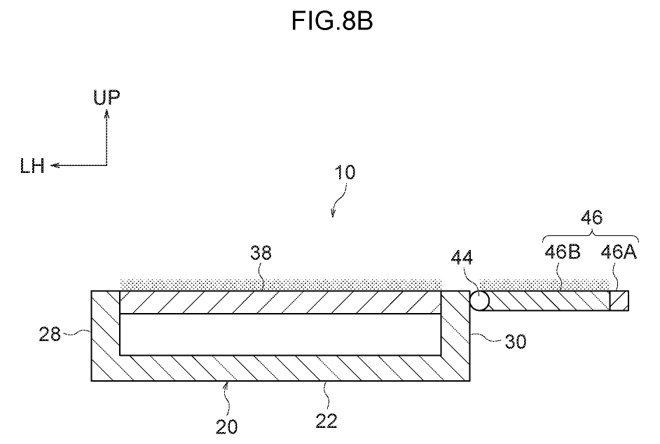

The vehicle storage device 10 configured as described above may be used in five modes, as illustrated in FIG. 8A to FIG. 12B. Note that dots are appended as appropriate to locations heated by the heaters in FIG. 8A to FIG. 12B. A luggage space L mode illustrated in FIG. 8A and FIG. 8B is a state in which the storage box 58 is not formed, and the floor F of the luggage space L is heated by the heaters attached to the first floor coupling panel 38, the second floor coupling panel 42, and the plate-shaped section 46B of the third floor coupling panel 46.

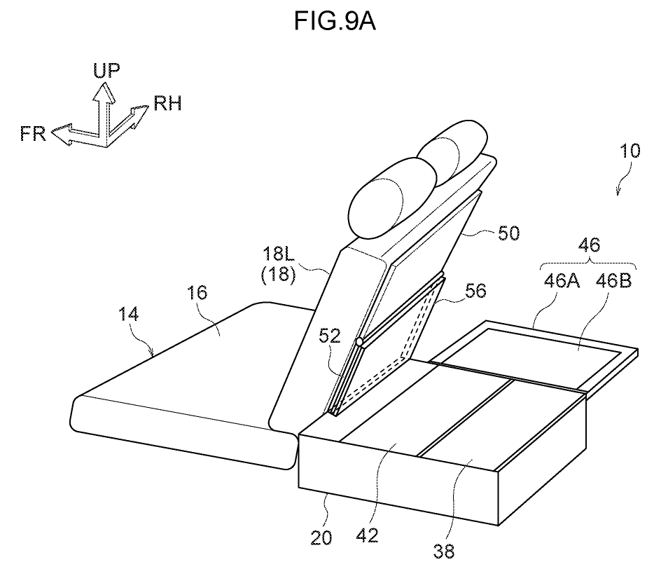

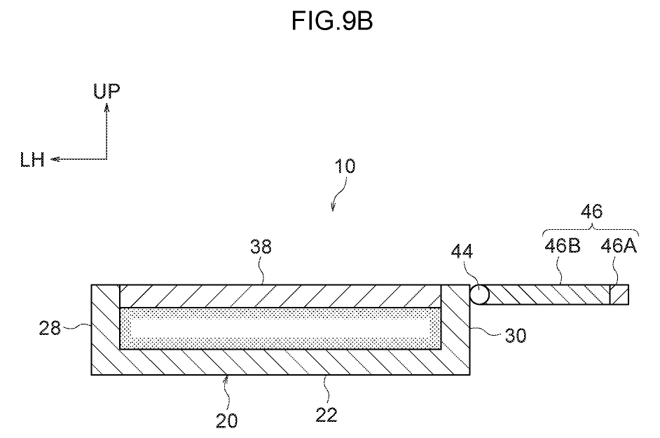

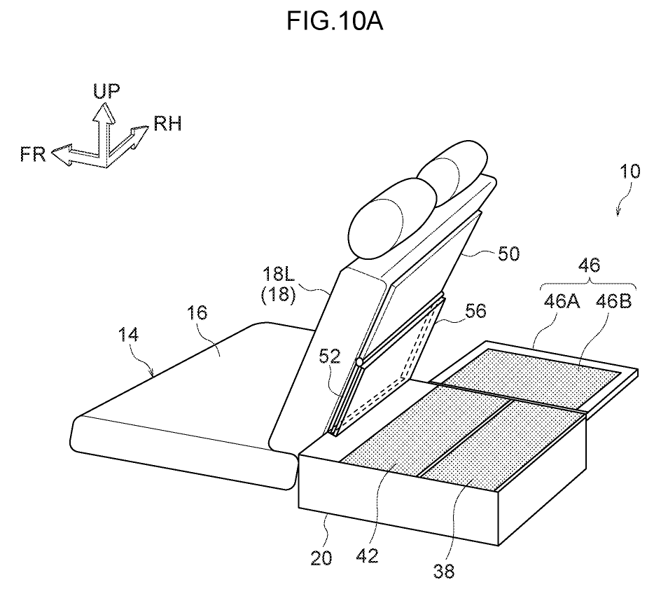

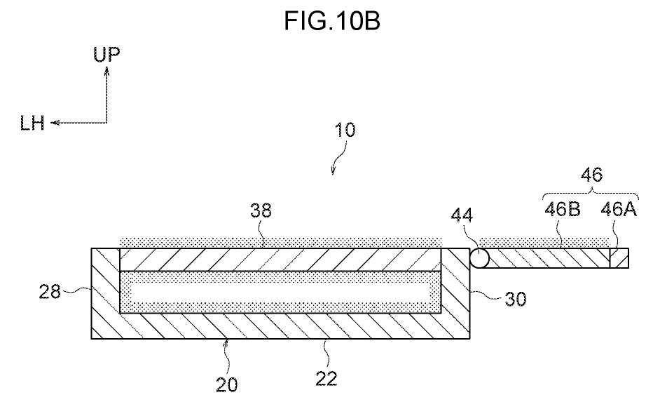

Moreover, a non-extended food mode illustrated in FIG. 9A and FIG. 9B is a state in which the storage box 58 is not formed, and the inside of the underfloor storage chamber 20 is heated by the heaters attached to the front wall 24, the rear wall 26, the left wall 28, the right wall 30, and the lower wall 22. This thereby enables, for example, the temperature to be maintained for food or the like stored inside the underfloor storage chamber 20. Moreover, in a luggage space L + non-extended food mode illustrated in FIG. 10A and FIG. 10B is a state in which the floor F of the luggage space L and the inside of the underfloor storage chamber 20 are heated by the respective heaters.

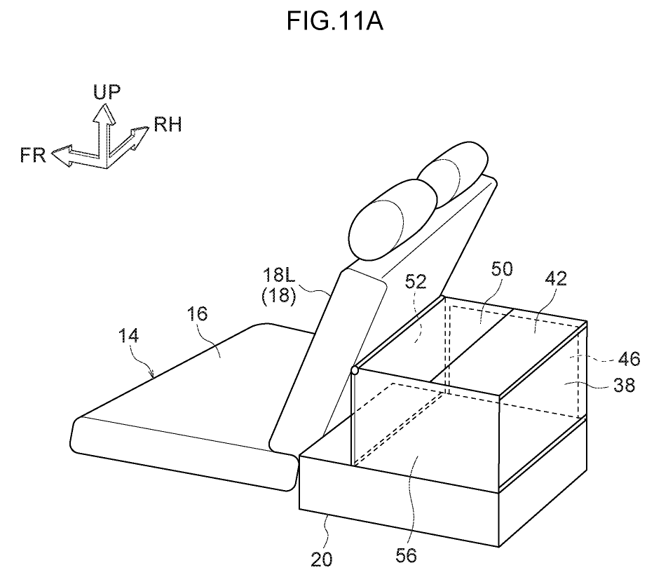

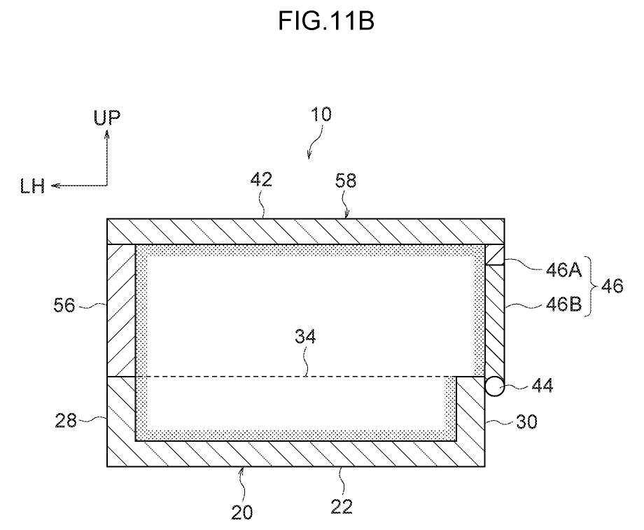

Moreover, an extended food mode illustrated in FIG. 11A and FIG. 11B is a state in which the storage box 58 has been formed and the inside of the underfloor storage chamber 20 is heated by the heaters attached to the front wall 24, the rear wall 26, the left wall 28, the right wall 30, and the lower wall 22, and also the inside of the storage box 58 is heated by the heaters attached to the first floor coupling panel 38, the second floor coupling panel 42, the plate-shaped section 46B of the third floor coupling panel 46, the first seat coupling panel 50, the second seat coupling panel 52, and the third seat coupling panel 56. This thereby enables, for example, the temperature to be maintained for food or the like stored inside the underfloor storage chamber 20 and inside the storage box 58.

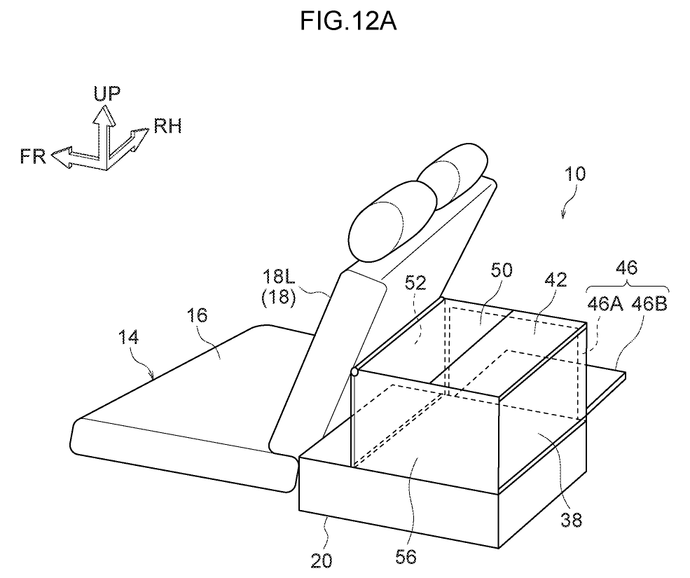

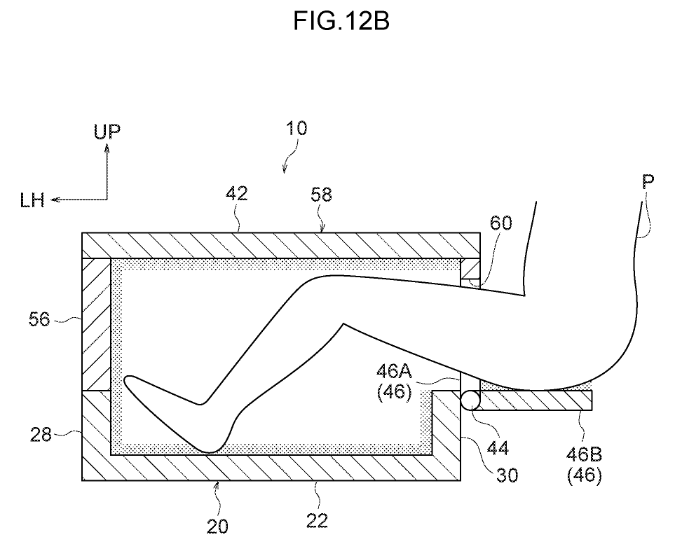

Moreover, a kotatsu mode illustrated in FIG. 12A and FIG. 12B is a state in which the storage box 58 is formed and the plate-shaped section 46B of the third floor coupling panel 46 is stowed on the floor surface FS, the inside of the underfloor storage chamber 20 is heated by heaters attached to the front wall 24, the rear wall 26, the left wall 28, the right wall 30, and the lower wall 22, and also the inside of the storage box 58 is heated by the heaters attached to the first floor coupling panel 38, the second floor coupling panel 42, the first seat coupling panel 50, the second seat coupling panel 52, and the third seat coupling panel 56.

In this kotatsu mode, the feet of a vehicle passenger P can enter inside the storage box 58 and inside the underfloor storage chamber 20 through the opening section 60, and the storage box 58 can be utilized as a table. In this kotatsu mode, the buttocks of the passenger P can be warmed by the heater attached to the plate-shaped section 46B of the third floor coupling panel 46. Note that a similar configuration to that of the third floor coupling panel 46 formed from the frame 46A and the plate-shaped section 46B may also be applied to the first floor coupling panel 38. In such cases, as well as being able to utilize in the kotatsu mode, access to the inside of the storage box 58 from the vehicle rear side is facilitated.

In the vehicle storage device 10 configured as described above, the underfloor storage chamber 20 formed under the floor of the luggage space L at the rear side of the rear seat 14 of the vehicle V is open to the upper side. The first floor coupling panel 38, the second floor coupling panel 42, and the third floor coupling panel 46 are rotatably coupled to edge portions of the opening section 34 of the underfloor storage chamber 20. The first seat coupling panel 50, the second seat coupling panel 52, and the third seat coupling panel 56 are rotatably coupled to the back face of the left seatback 18L of the rear seat 14.

In the vehicle storage device 10, the opening section 34 of the underfloor storage chamber 20 are configured to be openable/closeable by the first floor coupling panel 38 and the second floor coupling panel 42. Moreover, in the vehicle storage device 10, the storage box 58 having an interior in communication with the inside of the underfloor storage chamber 20 can be formed by the respective coupling panels 38, 42, 46, 50, 52, 56 above the underfloor storage chamber 20.

Because the vehicle storage device 10 is not configured with the respective coupling panels 38, 42, 46, 50, 52, 56 stowed inside the underfloor storage chamber 20, objects can be stored inside the underfloor storage chamber 20 even in a state in which the storage box 58 is not formed. This thereby enables convenience to be improved. Moreover, in a state in which the storage box 58 is not formed, the respective coupling panels 38, 42, 46, 50, 52, 56 are stowed on the floor F of the luggage space L and on the back face of the left seatback 18L, thereby achieving a configuration in which the respective coupling panels 38, 42, 46, 50, 52, 56 are not in way.

Moreover, in the vehicle storage device 10, due stowing the third floor coupling panel 46, which is the right side wall of the storage box 58, such that only the plate-shaped section 46B thereof is superimposed on the floor surface FS of the luggage space L, the opening section 60 can be formed in the right side wall of the storage box 58. This thereby enables, as described above, a passenger P of the vehicle V to sit on the plate-shaped section 46B with feet entering inside the storage box 58 and the underfloor storage chamber 20 through the opening section 60, and the storage box 58 to be utilized as a table. The plate-shaped section 46B on which the passenger P is sitting is a plate-shaped cushion, and so good seating comfort can be achieved for the passenger P.

Furthermore, the vehicle storage device 10 includes a floor surface of the luggage space L, and plural heaters that are able to heat the inside of the underfloor storage chamber 20 and the inside of the storage box 58, respectively. This means that, for example, the comfort of a pet, such as a dog, lying in the luggage space L can be improved by heating the floor surface of the luggage space L with the heaters. Moreover, the heaters inside the underfloor storage chamber 20 can heat in a state in which the storage box 58 is not formed, and the respective heaters inside the underfloor storage chamber 20 and the storage box 58 can heat in a state in which the storage box 58 has been formed. This thereby enables the temperature to be maintained of food stored inside the underfloor storage chamber 20 and inside the storage box 58.

Furthermore, due to being able to directly heat the buttocks of the passenger P with the heaters provided to the plate-shaped section 46B of the third floor coupling panel 46 in the kotatsu mode described above, the comfort of the passenger P can be raised efficiently. Moreover, the frame 46A of the third floor coupling panel 46 is covered by a cover, enabling a cold feeling to be avoided when touched by the passenger P.

Moreover, in the vehicle storage device 10, the second floor coupling panel 42 and the first seat coupling panel 50 serve as a lid for the storage box 58 enabling objects to be stored safely inside the storage box 58 even when, for example, a pet such as a dog is inside the luggage space L. Moreover, objects can be placed on the storage box 58, and so easily damaged food, such as cakes, donuts, sushi, or the like, can be stored safely inside the storage box 58.

Note that a configuration may be adopted in the above exemplary embodiment in which, for example, cool air from an air conditioner of the vehicle is introduced to inside the underfloor storage chamber 20. This thereby enables cooling of food and the like stored inside the underfloor storage chamber 20 and inside the storage box 58.

Moreover, although in the above exemplary embodiment the vehicle storage device 10 is configured provided with the second floor coupling panel 42, there is no limitation thereto. The second floor coupling panel 42 may be omitted in cases in which the front-rear direction dimensions of the underfloor storage chamber 20 and the storage box 58 are short. Moreover, the first floor coupling panel 38 and the second floor coupling panel 42 may be integrated together by an integral hinge so as to serve as a “one floor coupling panel”.

Various other modifications may be implemented within a range not departing from the spirit of the present disclosure. Moreover, obviously the scope of rights of the present disclosure is not limited to the above exemplary embodiments.

What is claimed is:

1. A vehicle storage device comprising:
an underfloor storage chamber that is formed under a floor of a luggage space at a vehicle rear side of a vehicle rear seat and that is open to a vehicle upper side;
a plurality of floor coupling panels rotatably coupled to edge portions of an opening section of the underfloor storage chamber; and
a plurality of seat coupling panels rotatably coupled to a back face of a seatback of the rear seat,
wherein the opening section of the underfloor storage chamber is configured to be openable/closeable by one or more of the floor coupling panels, and the plurality of floor coupling panels and the plurality of seat coupling panels are able to form a storage box having an interior in communication with an inside of the underfloor storage chamber, at a vehicle upper side of the underfloor storage chamber.

2. The vehicle storage device of claim 1, wherein:
one floor coupling panel forming a side wall of the storage box from among the plurality of floor coupling panels includes a frame configuring an outer edge portion of the one floor coupling panel, and a plate-shaped section that fits to an inside of the frame; and
the frame and the plate-shaped section are each rotatably coupled to an edge portion of the opening section, and are each able to be stowed so as to be parallel to a floor surface of the luggage space.

3. The vehicle storage device of claim 2, wherein the plate-shaped section is a plate-shaped cushion.

4. The vehicle storage device of claim 1, further comprising a plurality of heaters that are able to respectively heat a floor surface of the luggage space, the inside of the underfloor storage chamber, and an inside of the storage box.
